(19) United States
(12) Patent Application Publication
(10) Pub. No.: US 2007/0128393 A1
(43) Pub. Date: Jun. 7, 2007

(54) Heat sealable PCTFE film and tubing using high VF2 containing copolymers of CTFE/VF2

(76) Inventors: Jeffrey D. Moulton, Morristown, NJ (US); Simon J. Porter, Allentown, PA (US); Eric J. Rainal, Morristown, NJ (US); Yuan-Ping R. Ting, Plainsboro, NJ (US); Michael Schumann, Hamburg (DE)

Correspondence Address: Richard S. Roberts;Roberts & Roberts, L.L.P, Attorneys at Law, P.O. Box 484, Princeton, NJ, 08542-0484, US

(21) Appl. No.: 11/295,072

(22) Filed: Dec. 6, 2005

(51) Int. Cl. B32B 27/08; B32B 1/08; B29D 22/00

(52) U.S. Cl. 428/36.9; 428/35.7

(57) ABSTRACT

Heat sealable fluoropolymer-containing films and articles. More particularly, heat sealable films, tubes, packages, and other articles formed from a chlorotrifluoroethylene/vinylidene fluoride copolymer containing about 5% to about 25% vinylidene fluoride. The copolymers are capable of being formed into single or multilayer films that are heat sealable using conventional heat sealing methods while maintaining excellent clarity and moisture barrier properties.

### BACKGROUND OF THE INVENTION

1. Field of the Invention

The invention relates to heat sealable films, tubes, packages, and other articles. More particularly, the invention pertains to heat sealable films and articles formed from a copolymer having a chlorotrifluoroethylene component and a vinylidene fluoride component. The films and articles are capable of being heat sealed using conventional heat sealing methods while maintaining excellent moisture barrier properties.

2. Description of the Related Art

A wide variety of thermoplastic polymers, and films formed from thermoplastic polymers are known. Important physical characteristics of thermoplastic polymer films include barrier properties, such as barriers to gas, aroma and moisture, as well as its physical characteristics, such as toughness, wear and weathering resistances, and light-transmittance. These properties are especially important in film applications such as, for example, in the use of films as a packaging material for food or medical products.

It is known in the art to produce multicomponent structures incorporating different properties exhibited by the various individual components in a single film structure. For example, in packaging applications, it is desirable to use fluoropolymers which are known for their barrier properties, inertness to most chemicals, resistance to high temperatures and low coefficients of friction. Polychlorotrifluoroethylene (“PCTFE”) homopolymers and copolymers, and ethylene-chlorotrifluoroethylene (“ECTFE”) alternating copolymers, are particularly advantageous due to their excellent moisture barrier properties.

A variety of different thermoplastics have been coextruded with fluoropolymers to form multilayered films. For example, fluoropolymer containing multilayer films could include a layer of nylon to improve toughness, or a layer of ethylene vinyl alcohol as an oxygen barrier. However, fluoropolymers do not adhere strongly to most other polymers. In fact, most fluoropolymers are known for their non-stick characteristics. This is very disadvantageous, because poor bond strength between layers can result in the delamination of multilayer films. Fluoropolymer films are also known to have poor heat sealability properties. Accordingly, to improve the bond strength between a layer of a fluoropolymer and a layer of a non-fluoropolymer layer, or to improve the heat sealability of fluoropolymers to containers, an adhesive material, e.g. as a tie layer, is typically required.

Methods of making films and film structures from PCTFE polymers and copolymers using intermediate adhesive layers are known in the art. Examples are shown in U.S. Pat. Nos. 4,659,625, 4,677,017, 5,139,878 and 5,874,035. U.S. Pat. No. 4,659,625 discloses a fluoropolymer multilayer film structure which utilizes a vinyl acetate polymer adhesive layer. U.S. Pat. No. 4,677,017 discloses coextruded multilayer films which include a fluoropolymer and a thermoplastic film which are joined by an adhesive polymer. U.S. Pat. No. 5,139,878 discloses a fluoropolymer film structure using an adhesive layer of modified polyolefins.

U.S. Pat. No. 5,874,035 discloses highly oriented fluoropolymer films having a fluoropolymer, a polyolefin layer and a modified polyolefin intermediate adhesive layer.

While the aforementioned materials have been useful as lidding and packaging products, the need for an adhesive material is nonetheless disadvantageous. Particularly, it has been found that the high temperatures involved in conventional heat sealing techniques causes adhesive materials to crystallize at the heat seal sections of the structure. This crystallization results in a poor moisture barrier at the heat seal sections, and thus a reduced usefulness of the overall fluoropolymer packaging structure.

Accordingly, there remains a need in the art for a multicomponent fluoropolymer structure that is heat sealable while maintaining the excellent barrier properties of single component fluoropolymer structures. More particularly, it is desirable in the art to produce structures including single and multilayer fluoropolymer-containing film structures that are heat sealable to themselves. The films and articles of the invention provide a solution to this need in the art. The invention provides heat sealable films and heat sealable articles formed from a copolymer comprising a chlorotrifluoroethylene (“CTFE”) component and a vinylidene fluoride (“VDF”, or “VF2”) component, the vinylidene fluoride component comprising from about 5% by weight to about 25% by weight of said copolymer composition.

Vinylidene fluoride-chlorotrifluoroethylene copolymers having from 5% to 25% by weight of said vinylidene fluoride component have been found to have excellent heat sealability, clarity and barrier properties when formed into films, packages and other articles. More particularly, films, tubes and other articles of the invention have been found to be self-sealable under conventional heat sealing conditions without requiring an adhesive. In comparison, fluoropolymer-containing homopolymers and vinylidene fluoride-chlorotrifluoroethylene copolymers containing less than 5% vinylidene fluoride exhibit poor heat sealability. Further, vinylidene fluoride-chlorotrifluoroethylene copolymers having greater than about 25% of said vinylidene fluoride component are extremely difficult to extrude into films and have unacceptable clarity for packaging applications. In addition to mono and multilayer heat sealable films, also provided are packages, bottles, tubes and other articles formed from a CTFE/VDF copolymer having from about 5% to about 25% of VDF which may be heat sealed using conventional heat sealing methods. These structures are useful for a variety of end applications, such as for medical packaging, pharmaceutical packaging, e.g. blister packs for pills, food packaging and other uses.

### SUMMARY OF THE INVENTION

The invention provides a package formed from a film, which film comprises at least one layer of a copolymer composition, which copolymer composition comprises a chlorotrifluoroethylene component and a vinylidene fluoride component, the vinylidene fluoride component comprising from about 5% by weight to about 25% by weight of said copolymer composition.

The invention also provides a multilayer film comprising:

a) at least one fluoropolymer-containing polymer layer having first and second surfaces; and

b) a first layer of a copolymer composition attached to the first surface of the fluoropolymer-containing polymer layer; which copolymer composition comprises a chlorotrifluoroethylene component and a vinylidene fluoride component, the vinylidene fluoride component comprising from about 5% by weight to about 25% by weight of said copolymer composition.

The invention further provides a tube formed from a copolymer composition, which copolymer composition comprises a chlorotrifluoroethylene component and a vinylidene fluoride component, the vinylidene fluoride component comprising from about 5% by weight to about 25% by weight of said copolymer composition.

The invention still further provides a process for forming a package comprising:

a) forming a copolymer composition comprising a chlorotrifluoroethylene component and a vinylidene fluoride component, the vinylidene fluoride component comprising from about 5% by weight to about 25% by weight of said copolymer composition;

b) extruding at least one layer of the copolymer composition;

c) positioning said at least one layer to form an overlap having a top edge and side edges; and

d) heat sealing together said side edges and optionally said top edge, thereby forming a package.

The invention also provides a process for forming a tube comprising:

a) forming a copolymer composition comprising a chlorotrifluoroethylene component and a vinylidene fluoride component, the vinylidene fluoride component comprising from about 5% by weight to about 25% by weight of said copolymer composition; and

b) extruding at least one tube of said copolymer composition.

### DETAILED DESCRIPTION OF THE INVENTION

The invention provides heat sealable films, tubes, packages, and other articles formed from a copolymer composition, which copolymer composition comprises a chlorotrifluoroethylene component and a vinylidene fluoride component, the vinylidene fluoride component comprising from about 5% by weight to about 25% by weight of said copolymer composition. The films of the invention include monolayer films of said CTFE/VDF copolymer composition, as well as multilayer films comprising, for example, at least one layer of a fluoropolymer, e.g. polychlorotrifluoroethylene homopolymer, attached to at least one layer of the CTFE/VDF copolymer. As a result of the PCTFE and the CTFE/VDF copolymer composition being very similar in nature, a strong bond is achieved between layers of said PCTFE and CTFE/VDF materials without needing a tie layer. Articles formed from the copolymer composition include packages, tubes, bottles, lids and other articles, including various articles formed from single and multilayer films comprising the copolymer of the invention.

Methods for preparing CTFE/vinylidene fluoride copolymers are known. See, for example, U.S. Pat. No. 5,453,477 which describes a method for the production of PCTFE/VDF resin suspensions using a catalyst system comprising t-butylhydroperoxide, sodium-m-bisulfite, and iron (II) sulfate hydrate. U.S. Pat. No. 5,955,556 describes an improvement to the process of U.S. Pat. No. 5,453,477 using a surfactant free emulsion polymerization method.

Copolymers of CTFE and vinylidene fluoride are commonly produced via either suspension or emulsion polymerization processes. The CTFE/VDF copolymer compositions having about 5% by weight to about 25% by weight of the VDF moiety, from which the films and articles of the invention are formed, are preferably polymerized by conventional free-radical polymerization methods. Any commercially available radical initiator may be used in the present invention. Suitable candidates include thermal initiators and oxidation-reduction or “redox” initiator systems. Thermal initiators include: metal persulfates such as potassium persulfate and ammonium persulfate; organic peroxides or hydroperoxides such as diacyl peroxides, ketone peroxides, peroxyesters, dialkyl peroxides and peroxy ketals; azo initiators such as 2,2′-azobisisobutyronitrile and water-soluble analogues thereof; and mixtures and combinations thereof.

Generally, any redox initiator system known to be useful in the preparation of fluoropolymers such as PCTFE may be used in the present invention. Typical redox initiator systems comprise: 1) an organic or inorganic oxidizing agent or mixtures thereof; and 2) an organic or inorganic reducing agent or mixtures thereof. Suitable oxidizing agents include metal persulfates such as potassium persulfate and ammonium persulfate; peroxides such as hydrogen peroxide, potassium peroxide, ammonium peroxide, tertiary butyl hydroperoxide (“TBHP”) ((CH₃)₃ COOH)), cumene hydroperoxide, and t-amyl hydroperoxide; manganese triacetate; potassium permanganate; ascorbic acid and mixtures thereof. Suitable reducing agents include sodium sulfites such as sodium bisulfite, sodium sulfite, sodium pyrosulfite, sodium-m-bisulfite (“MBS”) (Na₂S₂O₅) and sodium thiosulfate; other sulfites such as ammonium bisulfite; hydroxylamine; hydrazine; ferrous irons; organic acids such as oxalic acid, malonic acid, citric acid and combinations thereof.

The preferred free radical initiating system is one that serves to simultaneously emulsify the polymer while initiating the polymerization, thus eliminating the need for large quantities of surfactants. Redox initiator systems are the preferred radical initiator.

Preferred redox initiator systems use an MBS reducing agent and a TBHP oxidizing agent. In a more preferred embodiment, the redox initiator system is used in conjunction with a transition metal accelerator. Accelerators can greatly reduce the polymerization time. Any commercially available transition metal may be used as an accelerator. Preferred transition metals include copper, silver, titanium, ferrous iron and mixtures thereof. Ferrous iron is most preferred.

The amount of radical initiator used in the process depends on the relative ease with which the various monomers copolymerize, the molecular weight of the polymer and the rate of reaction desired. Generally, from about 10 to about 100,000 ppm of initiator may be used, although from about 100 to about 10,000 ppm is preferred.

Optionally, in order to further accelerate the polymerization, the redox initiator system may include additional peroxide-based compounds. The amount of additional peroxide-based compound used ranges from about 10 to about 10,000 ppm and preferably from about 100 to about 5,000 ppm. The radical initiator may be added before, simultaneous with and/or shortly after the addition and/or consumption of the monomers used to make the copolymer. When an additional peroxide-based compound is used it may be added at the same interval specified for the primary radical initiator.

A preferred process for the preparation of the copolymers of the present invention is described in commonly owned U.S. Pat. No. 6,759,131, which is incorporated herein by reference. U.S. Pat. No. 6,759,131 describes a polymerization reaction in which monomers, water and an initial charge of radical initiator are introduced into suitable polymerization vessel. Additional monomer is added throughout the reaction at a rate equal to the rate of consumption to maintain a constant pressure. Incremental additional charges of initiator are introduced into the vessel over the duration of the reaction to sustain the polymerization. The reaction mixture is maintained at a controlled temperature while all reactants are being charged to the vessel and throughout the polymerization reaction.

The only requirement for the reaction vessel used to prepare the CTFE/VDF copolymer is that it be capable of being pressurized and agitated. Conventional commercial autoclaves which can be sealed and pressurized to the required reaction pressures (preferably less than 3.36 MPa (500 psig) for safety considerations) are preferred. Horizontally inclined autoclaves are preferred to vertically inclined autoclaves, although both geometries can be used. Preferably, the reactor vessel is lined with a fluoropolymer or glass liner.

The aqueous medium in which the polymerization is conducted is preferably deionized, nitrogen-purged water. Generally, an amount equivalent to approximately half the capacity of the autoclave is used. The ratio of polymer to water is chosen in such a way to obtain a dispersion of about 20 to about 60% polymer solids in water. The water is pre-charged to the autoclave.

The monomers may be charged to the reactor vessel either in a semicontinuous or a continuous manner during the course of the polymerization. “Semicontinuous” means that a number of batches of the monomers are charged to the reactor during the course of the polymerization reaction. In the preferred embodiment of the invention, the chlorotrifluoroethylene and vinylidene fluoride components are added to the reactor vessel at a CTFE:VDF weight ratio of from about 3:1 to about 19:1, more preferably from about 10:1 to about 19:1, and most preferably from about 15:1 to about 19:1.

The molar ratio of total monomer consumed to radical initiator will depend upon the molecular weight desired. Preferably, the overall mole ratio of monomer to initiator would be from about 10 to about 10,000, more preferably from about 50 to about 1,000, and most preferably from about 100 to about 500 moles of total monomer to one mole of initiator.

The radical initiator is generally added incrementally over the course of the reaction. For purposes of this discussion, “initial charge” or “initial charging” of initiator refers to a rapid, large, single or incremental addition of initiator to effect the onset of polymerization. In the initial charge, generally between about 10 ppm/min to about 1,000 ppm/min is added over a period of from about 3 to about 30 minutes, either before, after, or during the charging of the monomers. “Continuous charge” or “continuous charging” means the slow, small, incremental addition of initiator over a period of from about 1 hour to about 6 hours, or until polymerization has concluded. In the continuous charge, generally between about 0.1 ppm/min to about 30 ppm/min of initiator is added.

During the initiation of the polymerization reaction, the sealed reactor and its contents are maintained at the desired reaction temperature, or alternately to a varying temperature profile which varies the temperature during the course of the reaction. Control of the reaction temperature is another important factor for establishing the final molecular weight of the chlorofluoropolymers produced. As a general rule, polymerization temperature is inversely proportional to product molecular weight. Typically, the reaction temperature should range between about 0° C. to about 150° C., although temperatures above and below these values are also contemplated. The reaction pressure is preferably between from about 172 KPa to about 5.5 MPa, and more preferably from about 345 KPa to about 4.2 MPa. Elevated pressures and temperatures will yield greater reaction rates.

The polymerization is preferably conducted under agitation to ensure proper mixing. Although the agitation rate and reaction time will typically depend upon the amount of CTFE:VDF product desired, one of ordinary skill in the art can readily optimize the conditions of the reaction without undue experimentation to get the claimed results. The agitation rate will generally be in the range of from about 5 to about 800 rpm and, preferably from about 25 to about 700 rpm, depending on the geometry of the agitator and the size of the vessel. The reaction time will generally range from about 1 to about 24 hours, and preferably from about 1 to about 8 hours.

The chlorofluoropolymers produced using the above process are self-emulsifiable chlorofluorinated macromolecules having inorganic, “surfactant-like” functional end groups that impart excellent latex stability to the polymer when present in very low concentration. The chlorofluoropolymers produced are thereby dispersed in the aqueous medium by the attachment of these inorganic fragments onto the end of the polymer repeating units, thus creating a surface active agent having both a hydrophobic component and a hydrophilic component. This attachment leads to micelle formation, or, if the concentration of functionalized end groups is high enough, to their complete dissolution in water.

The type of “surfactant-like” end groups produced depends upon the type of initiator system selected and the optional addition of compounds that might be incorporated into the polymer through chain transfer reactions. Examples of such emulsifying function end groups include, but are not limited to, sulfonates, carboxylates, phosphonates, phosphates and salts and acids thereof, ammonium salts and any mixture thereof.

The presence of sulfonic acid end groups most significantly affect the emulsification of the chlorofluoropolymers in water. The amount of these functional end groups in the dispersion can be determined by first purifying the dispersion by methods known to the art, such as by ion exchange or dialysis, titrating the dispersion with any known base such as aqueous sodium hydroxide or ammonium hydroxide, and then expressing the amount in terms of molar equivalents of titrated base. The amount of these functional end groups expressed in moles of equivalent NaOH may range between from about 0.0001 to about 0.5 moles of functional end groups per liter of chlorofluoropolymer dispersion obtained. The molar ratio of these functional end groups per fluoropolymer produced may range from about 1:10 to 10,000, preferably from about 1:10 to 1,000 and more preferably from about 1:50 to 500. A typical chlorofluoropolymer dispersion contains about 0.01 molar equivalents/kg of dry polymer.

Dispersions prepared using a surfactant-free emulsion process obtain stable dispersions having up to 40 weight % solids in water, which is obtained without a concentration step. Low levels of surfactants may be added to obtain higher levels of emulsified polymer in water (i.e., 40-60 weight %). Suitable surfactants will readily occur to those skilled in the art and include anionic, cationic and nonionic surfactants. The preferred dispersion is an anionic surfactant stabilized latex emulsion having from 0 to 0.25 weight % of an anionic emulsifier.

Perfluorinated anionic surfactants are preferred. Examples of suitable perfluorinated anionic surfactants include perfluorinated ammonium octanoate, perfluorinated alkyl/aryl ammonium (metal) carboxylates and perfluorinated alkyl/aryl lithium (metal) sulfonates wherein the alkyl group has from about 1 to about 20 carbon atoms. Suitable surfactants also include fluorinated ionic or nonionic surfactants, hydrocarbon-based surfactants such as the alkylbenzenesulfonates or mixtures of any of the foregoing.

The chlorofluoropolymers produced by the above process may be isolated by conventional methods such as evaporating the water medium, freeze-drying the aqueous suspension, or adding a minor amount of an agglomerating or coagulating agent such as ammonium carbonate, followed by filtration or centrifuging. Alternatively and preferably the chlorofluoropolymer dispersion produced is used as is.

Depending upon the application desired, other components may also be included, such as wetting and leveling agents such as octylphenoxypolyethoxyethanol; pigments such as titanium dioxide; thickeners such as hydrophobe modified alkali swellable emulsions (HEURASE); defoamers; UV absorbers; plasticizers such as butyl benzylphthalate; biocides; fillers such as glass beads from 0.1-200 microns in size, as well as nanospheres; stain resists such as aqueous PTFE or fine powder PTFE; and the like. See, e.g., Handbook of Organic Coatings: A Comprehensive Guide for the Coatings Industry (NY 1990) or Handbook of Coatings Additives, (NY 1987). Other suitable processes for the formation of CTFE/VDF copolymers of the invention are also described in commonly owned U.S. Pat. Nos. 5,880,204 and 6,140,408, which are incorporated herein by reference.

As stated above, the CTFE/VDF copolymers from which the films and articles of the invention are formed preferably comprise about 5% by weight to about 25% by weight of said vinylidene fluoride component. More preferably, the CTFE/VDF copolymer comprises from about 5% by weight to about 20% by weight of said vinylidene fluoride component, more preferably from about 5% to about 17.5%, more preferably from about 5% to about 15%, more preferably from about 5% to about 12.5%, most preferably from about 5% to about 10%, and most preferably from about 5% to about 7.5% by weight of said vinylidene fluoride component. In the preferred embodiment of the invention, the CTFE component comprises the balance of the copolymer composition, preferably comprising from about 75% to about 95% of the copolymer depending on the VDF content of the copolymer.

The CTFE/VDF copolymer films of the invention comprise a layer having first and second surfaces. The copolymer layer may be attached to at least one fluoropolymer-containing polymer layer. Fluoropolymer materials are commonly known for their excellent chemical resistance and release properties as well as moisture and vapor barrier properties, and therefore are desirable components of packaging films. In the preferred embodiment of the invention, the fluoropolymer layer may be comprised of fluoropolymer homopolymers or copolymers or blends thereof as are well known in the art and are described in, for example, U.S. Pat. Nos. 4,510,301, 4,544,721 and 5,139,878. Preferred fluoropolymers include, but are not limited to, homopolymers and copolymers of chlorotrifluoroethylene, ethylene-chlorotrifluoroethylene copolymer, ethylene-tetrafluoroethylene copolymer, fluorinated ethylene-propylene copolymer, perfluoroalkoxyethylene, polychlorotrifluoroethylene, polytetrafluoroethylene, polyvinyl fluoride, polyvinylidene fluoride, and copolymers and blends thereof. The most preferred fluoropolymers useful for the fluoropolymer-containing polymer layer include homopolymers and copolymers of poly(chlorotrifluoroethylene). Particularly preferred are PCTFE (polychlorotrifluoroethylene homopolymer) materials sold under the ACLON™ trademark and which are commercially available from Honeywell International Inc. of Morristown, N.J.

As stated above, the invention provides for the formation of both monolayer structures, i.e. structures comprising a single layer of the CTFE/VDF copolymer, as well as multilayer structures. One preferred multilayer structure comprises a two-layer film comprising a single layer of the CTFE/VDF copolymer and a single PCTFE layer attached to a surface of the copolymer. Another preferred multilayered film comprises a three-layered film comprising a single fluoropolymer-containing layer, such as PCTFE, having first and second surfaces, and a layer of the CTFE/VDF copolymer attached to each of said first and second surfaces of the PCTFE layer. These film examples are non-limiting, and additional multilayer films may be formed and may optionally include non-fluoropolymer containing layers.

Each of the copolymer layer, fluoropolymer-containing layer and any other optional layers may optionally also include one or more conventional additives whose uses are well known to those skilled in the art. The use of such additives may be desirable in enhancing the processing of the compositions as well as improving the products or articles formed therefrom. Examples of such include: oxidative and thermal stabilizers, lubricants, release agents, flame-retarding agents, oxidation inhibitors, oxidation scavengers, dyes, pigments and other coloring agents, ultraviolet light absorbers and stabilizers, organic or inorganic fillers including particulate and fibrous fillers, reinforcing agents, nucleators, plasticizers, as well as other conventional additives known to the art. Such may be used in amounts, for example, of up to about 10% by weight of the overall composition. Representative ultraviolet light stabilizers include various substituted resorcinols, salicylates, benzotriazole, benzophenones, and the like. Suitable lubricants and release agents include stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides; as well as cuprous halides; and further, chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benylnesulfonamide, and combinations of any of the above, as well as other plasticizers known to the art.

A monolayer copolymer film is preferably formed using well known extrusion techniques. In a multilayer film, the copolymer layer or layers, the fluoropolymer layer or layers, and any other layers are preferably attached to each other by coextrusion. For example, the polymeric material for the individual layers, are fed into infeed hoppers of a like number of extruders, each extruder handling the material for one or more of the layers. The melted and plasticated streams from the individual extruders are fed into a single manifold co-extrusion die. While in the die, the layers are juxtaposed and combined, then emerge from the die as a single multiple layer film of polymeric material. After exiting the die, the film is cast onto a first controlled temperature casting roll, passes around the first roll, and then onto a second controlled temperature roll, which is normally cooler than the first roll. The controlled temperature rolls largely control the rate of cooling of the film after it exits the die. Additional rolls may be employed. In another method, the film forming apparatus may be one which is referred to in the art as a blown film apparatus and includes a multi-manifold circular die head for bubble blown film through which the plasticized film composition is forced and formed into a film bubble which may ultimately be collapsed and formed into a film. Processes of coextrusion to form film and sheet laminates are generally known. Typical coextrusion techniques are described in U.S. Pat. Nos. 5,139,878 and 4,677,017. The polymeric material may also be formed into tubes using techniques that are well known in the art, such as by extruding the polymeric material through an annular die.

Alternatively individual film layers may first be formed as separate layers and then laminated together under heat and pressure. Lamination techniques are well known in the art. Typically, laminating is done by positioning the individual layers on one another under conditions of sufficient heat and pressure to cause the layers to combine into a unitary film. Typically the individual layers are positioned on one another and the combination is passed through the nip of a pair of heated laminating rollers by techniques well known in the art. Typically, lamination may be conducted with or without intermediate adhesive layers. In the preferred embodiment of this invention, no intermediate adhesive layer is used in between the copolymer and fluoropolymer layers. Lamination heating may be done at temperatures ranging from about 120° C. to about 225° C., preferably from about 150° C. to about 175° C., at pressures ranging from about 5 psig (0.034 MPa) to about 100 psig (0.69 MPa), for from about 5 seconds to about 5 minutes, preferably from about 30 seconds to about 1 minute.

Each layer may be oriented prior to being joined. For the purposes of the present invention the term draw ratio is an indication of the increase in the dimension in the direction of draw. Preferably, in the present invention the layers are drawn to a draw ratio of from 1.5:1 to 5:1 uniaxially in at least one direction, i.e. its longitudinal direction, its transverse direction or biaxially in each of its longitudinal and transverse directions. Preferably, the layers are simultaneously biaxially oriented, for example orienting a plasticized film in both the machine and transverse directions at the same. This results in dramatic improvements in clarity strength and toughness properties. Preferably, the layers are biaxially oriented and not heat set so that it is shrinkable both in its transverse and longitudinal directions. Alternately, a multilayer film may be uniaxially or biaxially oriented as a whole after joining the individual film layers.

Although each layer of a film structure may have a different thickness, the thickness of the copolymer layer or layers is preferably from about 8 μm to about 254 μm, more preferably from about 8 μm to about 102 μm, and most preferably from about 8 μm to about 13 μm. The thickness of the fluoropolymer layer or layers, if present, is preferably from about 1 μm to about 250 μm, preferably from about 5 μm to about 225 μm and more preferably from about 10 μm to about 200 μm. Accordingly, the overall film thickness is preferably from about 9 μm to about 504 μm, more preferably from about 13 μm to about 327 μm, and most preferably from about 18 μm to about 213 μm. While such thicknesses are preferred, it is to be understood that other film thicknesses may be produced to satisfy a particular need and yet fall within the scope of the present invention.

The water vapor transmission rate (WVTR) of the heat sealable packages, films and articles may be determined via the procedure set forth in ASTM F1249. In the preferred embodiment, the packages, films and articles of the invention have a WVTR of from about 0.0005 to about 1 gm/100 in²/day of the overall film or article at 37.8° C. and 100% RH, preferably from about 0.001 to about 0.1 gm/100 in²/day of the overall film or article, and more preferably from about 0.003 to about 0.05 gm/100 in²/day of the overall film or article. As is well known in the art, the water vapor transmission rate is directly influenced by the thickness of the individual film layers as well as by the overall film thickness.

The heat sealable films of the invention are preferably heat shrinkable, generally by an amount of from about 2% to about 30%, more preferably from about 10% to about 20% in its length, or its width or each of its length and width. The films may further have printed indicia on or between layers. Such printing is typically on an internal surface of the structure and methods of application are well known in the art.

The copolymer and films of invention are useful in forming articles such as bags, pouches, containers and blister packages for the storage of food and medical products, or as lidding films on containers or trays. The containers and packages are suitable for packaging a variety of fresh produce, such as fruits and vegetables. The CTFE/VDF copolymers are also useful for forming articles such as bottles, tubes and various other structures. Such articles are formed through well known techniques in the art. The films are particularly useful for forming packages by heat sealing portions of the film to itself. For example, a single layer of said CTFE/VDF copolymer may be extruded, folded and positioned such that it is overlaid onto itself forming an overlap having a top edge and side edges, and heat sealing together the side edges and optionally the top edge to form a package. Heat sealing techniques are well known in the art, and involve the application heat to melt and fuse portions of the polymer layer together at temperatures ranging from about 150° C. to about 270° C., more preferably from about 200° C. to about 250° C., and pressures of from about 10 psia to about 100 psia, more preferably from about 60 psi to about 100 psi. Tubes may be formed by extruding the CTFE/VDF copolymers through suitable dies. As with the films of the invention, tubes formed from said CTFE/VDF copolymers are also heat sealable. For example, an end portion or side portion of a CTFE/VDF tube may be heat sealed to an end portion or side portion of another CTFE/VDF tube or other tube or article. For instance, a plurality of CTFE/VDF tubes may be sequentially heat sealed, end-to-end, to form a single, longer tube. Such heat sealing techniques are well known in the art. Importantly, the heat seal process forms an strong interlayer bond between copolymer film surfaces that has the same moisture barrier properties as the parent copolymer material, avoiding the need for an adhesive tie layer and overcoming the typical reduction in moisture barrier properties associated with low moisture barrier adhesive materials incorporated in prior art structures.

The following non-limiting examples serve to illustrate the invention.

### EXAMPLE 1

A polymerization vessel was heated to 82° C. Prior to polymerization, 2.65 m³ of water was charged to the vessel and the vessel was agitated and sparged with an inert gas. Next, 5.5 kg of potassium persulfate was dissolved in water, degassed and added to the vessel. Twenty six and a half liters of an acidified FeSO₄ solution (1.16 wt. % H₂SO₄) was then sparged and pumped into the reactor. Fifty two and two tenths kgs of a 6.68:1 ratio of chlorotrifluoroethylene monomer (CTFE) to vinylidene fluoride monomer (VDF) was then added to the reactor. A solution of 2.1 kg of sodium metabisulfite in 102.6 kg of water was sparged and pumped into the reactor. A second addition of 748.2 kg CTFE was then pumped into the reactor at a rate of less than 25 kg/min. A continuous addition of VDF monomer was also started at a similar rate. The total amount of VDF added was 72.6 kg. After 2 hours of polymerization, a continuous addition, at a rate less than 0.04 m³/hr, of a sodium metabisulfite solution containing FeSO₄ (1000:1) was added over the duration of the reaction. The total of sodium metabisulfite addition was 15 kg. After several hours of polymerization, a third addition of CTFE was added to the reactor. A total of 1404 kg of CTFE was added. Finally, 1.89 L of 50% sodium hydroxide in water was added, followed by a flush of deionized water. The produced polymer was washed, dried and pelletized. From the initial addition of the first metabisulfite solution until the sodium hydroxide addition, the reaction took 10.6 hours. IR analysis of the CTFE/VDF copolymer showed the VDF content as 4.85%.

### EXAMPLE 2

Employing the procedure set forth in Example 1 and the same aqueous polymerization system, a copolymer comprising 5% VDF and 95% CTFE was obtained. A sample of the copolymer was compression molded at 240° C. for 5 minutes and then quick quenched in ice water. After molding, the sample remained stiff but flexible and exhibited water-clear clarity. This co-polymer had a melt point of 191° C. based on DCS measurement, and had excellent heat seal bond strengths when sealed to itself at 218° C. with a dwell time of 3 seconds.

### EXAMPLE 3

Employing the procedure set forth in Example 1 and the same aqueous polymerization system, a copolymer comprising 7.5% VDF and 92.5% CTFE was obtained. A sample of the copolymer was compression molded at 225° C. for 5 minutes and then quick quenched in ice water. After molding, the sample remained flexible and exhibited cloudy-clear clarity. This co-polymer had a melt point of 178° C. based on DCS measurement. Pressed plaques had excellent heat seal bond strengths when sealed to itself at 218° C. with a dwell time of less than 5 seconds.

### EXAMPLE 4

Employing the procedure set forth in Example 1 and the same aqueous polymerization system, a copolymer comprising 10% VDF and 90% CTFE was obtained. A sample of the copolymer was compression molded at 200° C. for 2 minutes and then quick quenched in ice water. After molding, the sample remained very flexible and exhibited cloudy-opaque clarity. This co-polymer had a melt point of 124° C. based on DCS measurement. Pressed plaques had excellent heat seal bond strengths when sealed at 163° C. with a dwell time of less than 5 seconds.

### EXAMPLE 5

Employing the procedure set forth in Example 1 and the same aqueous polymerization system, a copolymer of 25% VDF and 75% CTFE was obtained. A sample of the copolymer was compression molded at 200° C. for 2 minutes and then quick quenched in ice water. After molding, the sample remained extremely flexible. Pressed plaques had excellent heat seal bond strengths when sealed to itself at 163° C. with a dwell time of less than 3 seconds.

### EXAMPLES 6-23

For Examples 6-23, film samples of 5% VDF-95% CTFE copolymer, ULTRX™ 2000 PCTFE homopolymer, and 2.57% VDF-97.43% CTFE copolymer were self-sealed under the conditions listed in Table 1 and tested for seal strength. Five samples of each film were tested and the mean max load for each sample is listed in the table. These examples illustrate a significant improvement in seal strength for a 5% VDF copolymer film compared to PCTFE homopolymer films and CTFE/VDF films having less than 5% vinylidene fluoride.

TABLE 1

| Seal Conditions | | | | | | |
|---|---|---|---|---|---|---|
| | Seal | | | | | |
| | Tem- | | Seal | Mean Max Load (lbs) | | |
| | per- | Dwell | Pressure | 5% VDF | ULTRX ™ | 2.57% VDF |
| EX | ature | Time | (psi) | Copolymer | 2000 | Copolymer |
| 6 | 400 | 3 | 65 | 2.29 | X | 0.138 |
| 7 | 425 | 1 | 65 | 1.16 | X | X |
| 8 | 425 | 2 | 65 | 7.02 | X | X |
| 9 | 425 | 3 | 65 | 7.90 | X | X |
| 10 | 450 | 1 | 65 | 7.86 | X | X |
| 11 | 450 | 2 | 65 | X | X | 0.162 |
| 12 | 450 | 3 | 65 | X | X | 1.26 |
| 13 | 475 | 0.5 | 65 | 7.08 | X | X |
| 14 | 475 | 1 | 65 | 9.27 | X | 0.229 |
| 15 | 475 | 2 | 65 | X | X | 2.776 |
| 16 | 475 | 3 | 65 | X | 0.08 | 3.775 |
| 17 | 500 | 0.5 | 65 | 9.66 | X | X |
| 18 | 500 | 1 | 65 | 8.64 | 1.08 | 1.106 |
| 19 | 500 | 2 | 65 | N/A | 0.63 | 6.587 |
| 20 | 500 | 3 | 65 | N/A | 2.34 | 8.247 |
| 21 | 525 | 1 | 65 | N/A | 4.35 | N/A |
| 22 | 525 | 2 | 65 | N/A | 3.03 | N/A |
| 23 | 525 | 3 | 65 | N/A | 6.52 | N/A |

N/A = Seal strength not tested at these conditions.
X = Material did not seal at these conditions.

### EXAMPLE 24

A CTFE/VDF copolymer composition comprising 5% VDF is formed in a reactor vessel by polymerizing vinylidene fluoride and chlorotrifluoroethylene components.

In molten form, the copolymer composition is extruded through a die to form a mono-layer copolymer film.

### EXAMPLE 25

Example 24 is repeated, except the copolymer layer is coextruded with a layer of PCTFE. The layers are attached to form a two-layer film.

### EXAMPLE 26

Example 24 is repeated, except the copolymer layer is coextruded with a layer of PCTFE and a second layer of said copolymer. The layers are attached to form a three-layer, copolymer/PCTFE/copolymer multilayer film structure.

### EXAMPLE 27

The copolymer film formed in Example 24 is folded in half to overlap itself, the overlap having a folded bottom edge, an open top edge, as well as open left and right side edges. The side edges are heat sealed under heat and pressure to form an enclosure having an open top. The enclosure is filled with a food product and the top edge is heat sealed under heat and pressure to form a sealed package.

### EXAMPLE 28

The two-layer film formed in Example 25 is folded in half to overlap itself, the overlap having a folded bottom edge, an open top edge, as well as open left and right side edges. The side edges are heat sealed under heat and pressure to form an enclosure having an open top. The enclosure is filled with a food product and the top edge is heat sealed under heat and pressure to form a sealed package.

### EXAMPLE 29

The three-layer film formed in Example 26 is folded in half to overlap itself, the overlap having a folded bottom edge, an open top edge, as well as open left and right side edges. The side edges are heat sealed under heat and pressure to form an enclosure having an open top. The enclosure is filled with a food product and the top edge is heat sealed under heat and pressure to form a sealed package.

### EXAMPLE 30

A CTFE/VDF copolymer composition comprising 5% VDF is formed in a reactor vessel by polymerizing vinylidene fluoride and chlorotrifluoroethylene components. In molten form, the copolymer composition is extruded through an annular die to form a tube.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A package formed from a film, which film comprises at least one layer of a copolymer composition, which copolymer composition comprises a chlorotrifluoroethylene component and a vinylidene fluoride component, the vinylidene fluoride component comprising from about 5% by weight to about 25% by weight of said copolymer composition.

2. The package of claim 1 wherein said vinylidene fluoride component comprises from about 5% by weight to about 12.5% by weight of said copolymer composition.

3. The package of claim 1 wherein said vinylidene fluoride component comprises from about 5% by weight to about 10% by weight of said copolymer composition.

4. The package of claim 1 wherein said vinylidene fluoride component comprises from about 5% by weight to about 7.5% by weight of said copolymer composition.

5. The package of claim 1 wherein said film further comprises a fluoropolymer-containing polymer layer having first and second surfaces, wherein said at least one copolymer layer is attached to at least one of said first and second surfaces.

6. The package of claim 5 wherein the fluoropolymer-containing polymer layer comprises polychlorotrifluoroethylene.

7. The package of claim 5 wherein said at least one copolymer layer is attached to both of said first and second surfaces of said fluoropolymer-containing polymer layer.

8. The package of claim 1 wherein said film comprises a single layer film of said copolymer composition.

9. A multilayer film comprising:
a) at least one fluoropolymer-containing polymer layer having first and second surfaces; and
b) a first layer of a copolymer composition attached to the first surface of the fluoropolymer-containing polymer layer; which copolymer composition comprises a chlorotrifluoroethylene component and a vinylidene fluoride component, the vinylidene fluoride component comprising from about 5% by weight to about 25% by weight of said copolymer composition.

10. The multilayer film of claim 9 which further comprises:
c) a second layer of said copolymer composition attached to the second surface of the fluoropolymer-containing polymer layer.

11. The multilayer film of claim 9 wherein the fluoropolymer-containing polymer layer comprises a polychlorotrifluoroethylene layer.

12. The multilayer film of claim 9 wherein said vinylidene fluoride component comprises from about 5% by weight to about 12.5% by weight of said copolymer composition.

13. The multilayer film of claim 9 wherein said vinylidene fluoride component comprises from about 5% by weight to about 10% by weight of said copolymer composition.

14. The multilayer film of claim 9 wherein said vinylidene fluoride component comprises from about 5% by weight to about 7.5% by weight of said copolymer composition.

15. An article formed from the multilayer film of claim 9.

16. The article of claim 15 which comprises a bottle.

17. The article of claim 15 which comprises a lid.

18. The article of claim 15 which comprises a container.

19. An article formed from the multilayer film of claim 10.

20. A tube formed from a copolymer composition, which copolymer composition comprises a chlorotrifluoroethylene component and a vinylidene fluoride component, the vinylidene fluoride component comprising from about 5% by weight to about 25% by weight of said copolymer composition.

21. The tube of claim 20 wherein said vinylidene fluoride component comprises from about 5% by weight to about 12.5% by weight of said copolymer composition.

22. The tube of claim 20 wherein said vinylidene fluoride component comprises from about 5% by weight to about 10% by weight of said copolymer composition.

23. The tube of claim 20 wherein said vinylidene fluoride component comprises from about 5% by weight to about 7.5% by weight of said copolymer composition.

24. A process for forming a package comprising:
a) forming a copolymer composition comprising a chlorotrifluoroethylene component and a vinylidene fluoride component, the vinylidene fluoride component comprising from about 5% by weight to about 25% by weight of said copolymer composition;
b) extruding at least one layer of the copolymer composition;
c) positioning said at least one layer to form an overlap having a top edge and side edges; and
d) heat sealing together said side edges and optionally said top edge, thereby forming a package.

25. The process of claim 24 wherein step b) further comprises coextruding and attaching at least one fluoropolymer-containing polymer layer with said at least one layer of the copolymer composition.

26. The process of claim 25 wherein the fluoropolymer-containing polymer layer comprises a polychlorotrifluoroethylene layer.

27. A process for forming a tube comprising:
a) forming a copolymer composition comprising a chlorotrifluoroethylene component and a vinylidene fluoride component, the vinylidene fluoride component comprising from about 5% by weight to about 25% by weight of said copolymer composition; and
b) extruding at least one tube of said copolymer composition.
